(19) United States
(12) Patent Application Publication
(10) Pub. No.: US 2021/0375112 A1
(43) Pub. Date: Dec. 2, 2021

(54) DEVICE, SYSTEM, AND METHOD FOR TEMPERATURE AND CONDITION ASSESSMENT OF INDIVIDUALS

(71) Applicant: Zahid F. Mian, (US)

(72) Inventors: Ryk E. Spoor, Troy, NY (US); Zahid F. Mian, Loudonville, NY (US)

(73) Assignee: Zahid F. Mian, Troy, NY (US)

(21) Appl. No.: 17/230,569

(22) Filed: Apr. 14, 2021

Related U.S. Application Data
(60) Provisional application No. 63/010,110, filed on Apr. 15, 2020.

(51) Int. Cl. G08B 21/04; G08B 21/18; H04N 5/33

(52) U.S. Cl. CPC G08B 21/0476; H04N 5/33; G08B 21/182; G08B 21/0453

(57) ABSTRACT

A system, and method for measuring biological and or other data of a target user or subject. In the preferred embodiment, the invention uses infrared imaging to obtain a temperature image of a diver's eye and analyzes the image to determine the diver's core temperature nonintrusively. The preferred embodiment may also include other sensors to monitor the diver's physical condition and circumstances, and can report anomalies to both the diver and a more remote interested party, such as a dive master. In the preferred embodiment, sensors and interfaces are connected to a central processing unit by underwater transmission, such as by short wavelength radio, while the remote party communicates with the system, such as by acoustic signal transmission.

### REFERENCE TO PRIOR APPLICATIONS

The current application claims the benefit of U.S. Provisional Application No. 63/010,110, titled “Device, System, and Method for Temperature and Condition Assessment of Individuals”, which was filed on 15 Apr. 2020, and which is hereby incorporated by reference.

### GOVERNMENT LICENSE RIGHTS

The U.S. Government has a paid-up license in this invention and the right in limited circumstances to require the patent owner to license others on reasonable terms as provided for by the terms of Contracts NO0014-05M-0283 awarded by the United States Navy/ONR.

### TECHNICAL FIELD

The present disclosure relates, generally, to the field of health monitoring and specifically to a device, system, and method for non-intrusively measuring the core temperature of individuals in situations, such as diving, where using typical methods of measuring core body temperature and other physiological parameters is difficult or impossible. In a preferred embodiment, the temperature measurement device and method is incorporated into a system that monitors multiple parameters relevant to a diver's health and safety. Other embodiments are also described.

### BACKGROUND

Scuba and other methods of diving are important in recreation, industry, and military operations. A diver, like an astronaut, is in a challenging environment, one which can kill him or her if their equipment fails, or if they fail to note telltale signs of trouble from their own bodies. Diving carries its own unique hazards, such as Decompression Sickness (DCS, generally caused by nitrogen absorbed into the body under pressure and then released as potentially lethal bubbles in the bloodstream and tissues), nitrogen narcosis, and others; in addition, the environment and conditions of diving often can exacerbate other potential health hazards, or provide confusing input that allows a diver to not notice conditions which would be more obvious on land. For example, most dives occur in water very much cooler than the body, and thus a diver rarely has the impression or sensation of sweating, even under considerable exertion; however, the diver will in fact be sweating, and is usually breathing air of very low humidity, and thus can become dehydrated without noticing it.

The combination of cool (sometimes frigid) water and cold breathing gas (cold due to expansion of gases from the compressed source) makes hypothermia (low body temperature) one of the greatest risks of a diver. Hypothermia can slow a diver's reaction time, reduce their attentiveness, cause poor judgment, and in extreme cases leads to unconsciousness and death. Many conventional means for assessing “core temperature” (the temperature maintained at the essential “core” areas of the body, such as heart, brain, lungs) are difficult or impossible to use underwater; ear (tympanic) infrared thermometers cannot be used as often the ear is directly exposed to water (depending on the exact design of equipment being used); the mouth and breathing passages are significantly chilled by the breathing mixture; temple thermometers will fail because surface body temperatures plummet in water while core temperature can remain very stable. Core temperature is a critical measurement because it is the drop in core temperature, not exterior temperatures, which determines the severity of hypothermia. Rectal thermometers give the best “core temperature” estimation, but even military divers find this uncomfortable and recreational divers would mostly refuse to use such approaches at all.

In addition, even if appropriate sensors can be found and used, the data must be displayed for the user and—for purposes of safety—either the diver's companions or, if available, the master diver or tender vessel itself. Tethered divers can of course have any data fed directly up and down the tether, but most recreational and many military and industrial dives are not and cannot be performed while tethered.

A device, system, and method is therefore required which permits the accurate determination of core temperature and other aspects related to diver's health, and which can convey this data to appropriate individuals or locations for action when needed, is therefore very much needed.

It is also notable that these demands may be applied to other individuals than divers, including participants in other sports such as marathon running where core temperature and other characteristics such as hydration are crucial to ensure safe performance in the sport, and individuals in other extreme environments such as arctic or desert areas where core temperature, hydration, and other physiological characteristics may be affected badly by the environment.

As discussed previously, many methods of measuring core temperature are difficult or impractical in a diving environment. Eye temperature presents an excellent candidate for alternative measurement for several reasons, including but not limited to the following.

The eyes are one of the very few areas protected (mostly) from water contact during diving. This is essential in diving since the function of the eyes relies on the differing index of refraction between the eyes and the medium they exist in—and that index of refraction is nearly identical to that of water. Thus nearly all divers wear air-filled masks.

For the majority of the time the environment inside the mask will include still air and relatively stable conditions—especially over the timeframe in which core temperature shifts are expected. Purging systems are included in some masks, and a mask may occasionally be taken off and then replaced, but these are short-term transient phenomena and should have minimal effect over the timespan of a core temperature shift.

The eye itself is heavily protected, with the majority of the eyeball's thermal mass embedded in the skull directly adjacent to the brain. The eye's blood supply is essentially the same as the brain's. While the exterior of the eye would be expected to be slightly lower than core temperature, due to the protected nature of the eye and its connection to interior systems one would also expect that variations in the temperature of the eye—especially absent any high winds, etc., to directly increase heat loss—would directly parallel core temperature.

Other researchers have considered using the eye as a core temperature indicator. Lawrence, et. al. (U.S. Pat. No. 7,336,987) describes a method and device for determining core temperature from the eye using various wavelengths of infrared radiation; their proposed recommended wavelengths (which are in the near-IR from 1.7 to 2.5 microns), however, present issues in that it would seem difficult to obtain sufficient light from the eye, as it is at a much lower temperature than this imaging range normally applies to. The wavelengths were selected because unlike longer IR wavelengths there is some penetration of these from the interior of the eye, which would naturally be a superior core temperature measurement criterion, but physics may preclude its use in practical situations; the instrumentation necessary to receive these wavelengths at a sensitivity even possibly sufficient is fairly large and extremely expensive—not practical for use in a widely-distributed device. In addition, methods or reasons for expecting the target environment to remain stable are not addressed, and use of this for human condition tracking in an active environment such as experienced by divers is not taught.

Koçak, Orgül, and Flammer (1999) examined the consistency and variability of corneal temperature, showing that it could be consistently obtained from the same subject and that it showed variation over the day which was (A) independent of environmental influences, and (B) lower in the morning and higher in the evening—a pattern which is identical to that seen in normal core temperature variations; human body temperature tends to be lower in the morning, especially shortly after awakening, and higher in the evening, as might be expected given the variation in metabolic rate between sleep and wakeful activity.

The Memphis Zoo and Mississippi State University have been investigating the use of ocular thermography to detect wildlife body temperatures. Dray, et. al., investigated the use of ocular thermography for use on beef cattle. It has been demonstrated that ocular temperature does correlate with body temperature, although there are external factors. If the external environment is fairly constant, the ocular temperature is a good indicator and may be good enough to be useful in this application.

This reinforces the point about the environment of the eye in a diving situation; the eye remains in the air, the mask environment shifts minimally except for very short periods if a “purge” is required or the mask is removed and replaced, and in these cases the environment re-stabilizes very quickly—much faster than expected core temperature variations.

Both Betts-Lacroix et al., and Laurence et al. have described the use of eye temperature to determine core temperature in experimental animals and in herd animals (such as cows), respectively, in U.S. Pat. Nos. 10,398,316 and 10,064,392 (Betts-Lacroix) and U.S. Pat. Nos. 10,098,327 and 8,317,720 (Laurence). Neither, however, describe the use of this technique for human beings, or a method for using the technique outside of very constrained circumstances, or the methods or reasons for which it might be applied to human beings performing in challenging environments.

Therefore, an infrared sensor capable of obtaining readings of the eye during a dive has not yet been properly proposed, but based on existing knowledge and work should be capable of closely tracking the core temperature with appropriate “offset” for calibration to real core temperature.

### SUMMARY

The present invention is a device, system, and method for non-intrusively measuring the core temperature and possibly other parameters of an individual, with other key health and safety sensing modalities possible, and tracking this parameter or parameters and providing alerts to the individual and/or other interested parties (such as a dive master). The device is a miniature infrared sensor with appropriate optics and low-power electronics to acquire an infrared image of at least one significant portion of the eye of an individual. In the preferred embodiment, the device is installed in a sealed diver's mask or helmet in a position to see the eye, with appropriate measures to prevent water ingress as known to those skilled in the art.

The system includes the device and possibly other sensors, and also includes processing hardware to acquire the data from the device and other sensors, and then processes this data to obtain the core temperature of the individual and other parameters that may be measured by the infrared image or by the other sensors, using calibration and compensation methods described herein or known to those skilled in the art. The system uses software to track the core temperature, and possibly other parameters, and is provided with hardware and software to permit it to alert the individual or another relevant party if the temperature passes outside of some set of approved bounds.

The method involves acquiring raw data from the sensor, performing calibration and compensation as needed, and from this determining the core temperature of the individual, with similar procedures for other relevant parameters of the individual. Further methodology includes evaluating the processed data and determining if an alert should be sent to the individual or another relevant party.

In the preferred embodiment, the device is part of a diver health monitoring system which tracks the diver's core temperature and other parameters such as gaze direction and eyelid position which may be analyzed to determine fatigue, attentiveness, and disorientation parameters. The monitoring system may also include other sensors which measure additional parameters such as blood pressure, oxygen levels, hydration, and so on, and is able to alert the diver or their dive master on the surface when these parameters fall outside of accepted values. The preferred embodiment incorporates a dual-mode communications system which uses wireless radio transmissions in the near field, and acoustic transmissions for longer distance Additional features and embodiments are described.

### BRIEF DESCRIPTION OF THE DRAWINGS

FIG. 1A illustrates a concept of operations of the preferred embodiment of the invention being employed by a diver

FIG. 1B illustrates details of the preferred embodiment of the invention through a closeup of the elements of the invention embodied in or on a diver's helmet or mask.

FIG. 2 illustrates a basic flowchart of processes of the invention.

FIG. 3 shows two infrared images of a face before and after immersion in ice water, demonstrating that the eye temperature remains constant.

FIG. 4 shows a set of high and low resolution infrared images of an eye closing and the results of processing of the image

FIG. 5 shows the preferred embodiment of the invention with locations of various sensors

FIG. 6A illustrates the basic design of a linear imaging array

FIG. 6B illustrates two methods of scanning an eye using a linear imaging array

FIG. 6C illustrates the assembly of a complete 2-D image from multiple linear imaging array images

### DETAILED DISCRIPTION

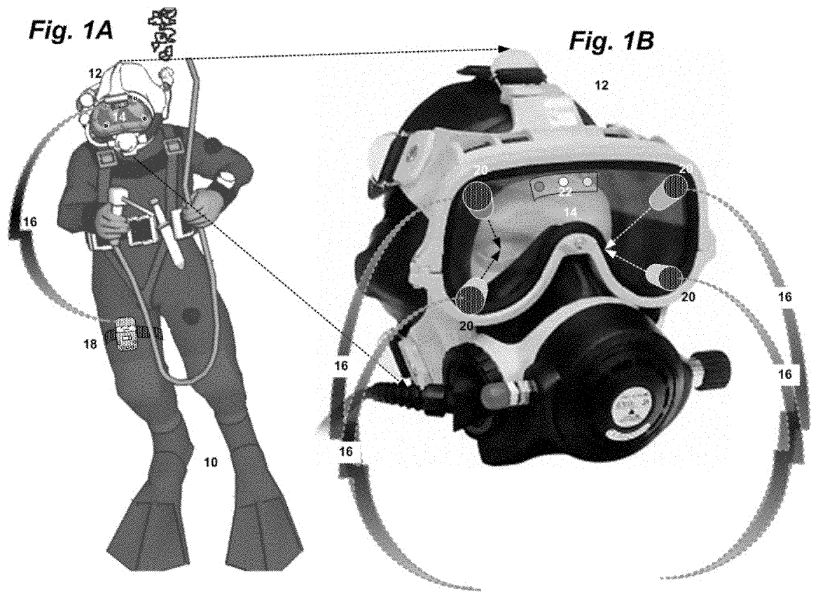

FIG. 1 depicts a conceptual version of the preferred embodiment. In FIG. 1A, diver 10 is underwater, wearing a mask 12 which incorporates an instrumented faceplate 14. While the type of mask 12 shown is an “oronasal” mask in design, nothing in this patent or discussion precludes the use of the subject invention on other types of masks or helmets, including those used in, for example, arctic environments, or in tether-fed diving suits, rather than in free-swimming diving. The faceplate's 14 instrumentation is shown more clearly in FIG. 1B. The instrumentation or sensor nodes attached to/integrated with faceplate 14 communicate via some wireless link 16 with a local or central data collection and processing system 18. FIG. 1B shows a closeup of mask/helmet 12, including the sensor nodes 20. One or more such nodes 20 are positioned such that they have an unobstructed view of the diver's 10 eye, while remaining out of the diver's 10 direct line of sight. FIG. 1B shows four such nodes, but the actual invention may use one or more nodes. One possible method of alerting the diver is also shown in the form of a mostly transparent LED display 22 at the top of the faceplate 14; such a display 22 could show different colors for good, questionable, and dangerous conditions, and evades one of the primary challenges of underwater vision—obscuration. Other methods would be vibration similar to that used by cell phones and pagers, sound, a more complex faceplate display, a wrist-mounted display similar to (and possibly incorporating features of) a diver's watch or depth gauge, and so on.

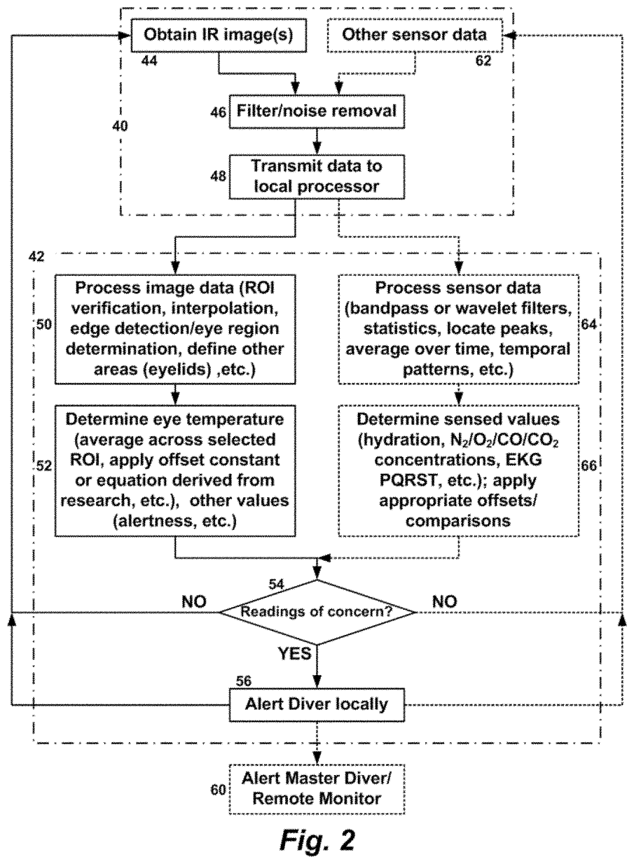

The system as envisioned would function in a general manner as illustrated in FIG. 2. Certain functions 40 are assumed to be performed by the sensor node 20 itself, while other functions 42 are assumed to be performed by the central data collection and processing system 18. Depending on the capability of the sensor nodes 20 different functions may be transferred to them or performed by them or by the central data collection and processing system 18.

In the preferred embodiment, the sensor node 20 obtains IR image(s) 44 and then filters them 46 as needed, performing simple processing to reduce noise. The data is then transmitted 48 to the data collection and processing unit 18 using wired or wireless means. The IR image data is then processed 50 in any number of desired ways. This could include interpolation or super-resolution approaches using multiple frames to improve resolution on a lower-resolution array, edge detection and segmentation to determine eye regions, histogram or contrast adjustment, defining regions of interest (eyeball, eyelid, etc.) and so on.

Following all basic processing, the system will make determinations 52 of particular conditions or parameters—core body temperature, whether eyelid movement or position indicates fatigue, etc., and pass these conditions or parameters to a decisionmaking engine 54 which will determine if the current conditions warrant an alert. The engine 54 may be a rule-based expert system, a fuzzy expert system, a Bayesian or neural network, or other method of evaluating and deciding upon courses of action based on input parameters.

If a condition for concern exists, the system will trigger an alert 56 (which may involve changing an LED in the previously illustrated LED display 22, vibrating the data collection unit 18, or other methods). If the data collection unit 18 is so equipped and if desired, a remote monitor such as a master diver or tender vessel may be alerted 60, again by wired or wireless means.

As also shown in FIG. 2, other sensor data 62 may be gathered, filtered 46, and be transmitted 48 to the central data collection and processing system 18 which performs functions 42. For other sensors there are processes 64 similar in concept to those performed 50 on the infrared images, which include but are not limited to bandpass filters, wavelet filters to assist in extracting specific features of the signal, averaging, Kalman filters to reduce error, analysis for temporal or spatial patterns, and so on. Similarly, determinations of the significance of the sensed values 66 will occur in similar wise to the determinations 52 done for the infrared images, and subsequent decisionmaking 54 and alerting 56 and 60 will be essentially the same.

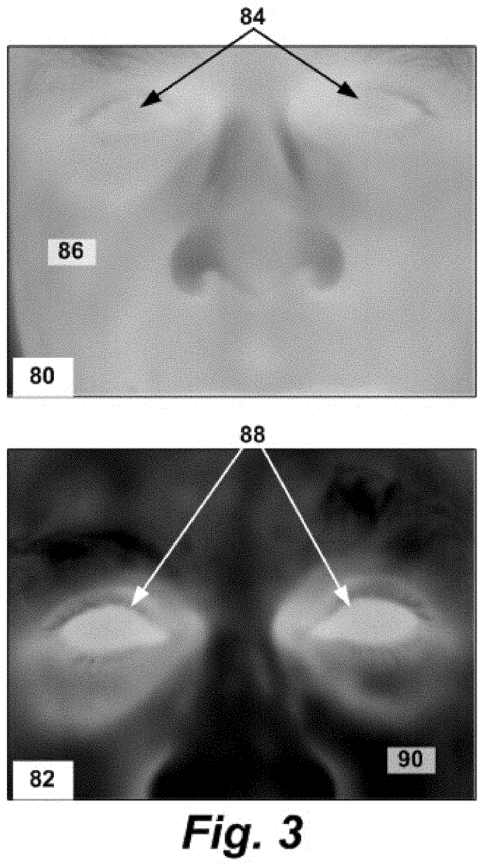

FIG. 3 illustrates the invariance of corneal temperature when compared to other nearby body components. One infrared photograph 80 shows a face and eyes under normal conditions, while a second infrared photograph 82 shows the same face immediately (within 5 seconds) after immersion for a minute in ice water. Note that during immersion the eyes themselves were opened, allowing the ice water direct contact with the eye. In both photographs 80 and 82, the lightness or darkness of a given location indicates temperature; lighter shades of gray indicate warmer temperatures, dark shading into black shows colder temperatures. In photograph 80, the eyes 84 can be seen, but are not tremendously different in temperature from their surroundings 86; the face appears to be at a roughly even temperature, with the nose slightly cooler (presumably due to the cooling effects of inhaled air).

In photograph 82, however, the eyes 88 appear to literally glow, the surrounding face 90 now deeply chilled; as both of these photographs 80 and 82 were taken using the same temperature scale, it is a point of significant interest that the actual shades of gray (and therefore temperatures) recorded at the eye have not changed significantly in any way, even though the eyes 88 themselves were exposed to ice-water temperatures only a few seconds before photograph 82 was taken. This and other data mentioned previously indicate that the eye temperature, while possibly variable in the very short term, will overall vary only with a change in temperature of the overall blood supply supporting it—in short, only with a change in core temperature.

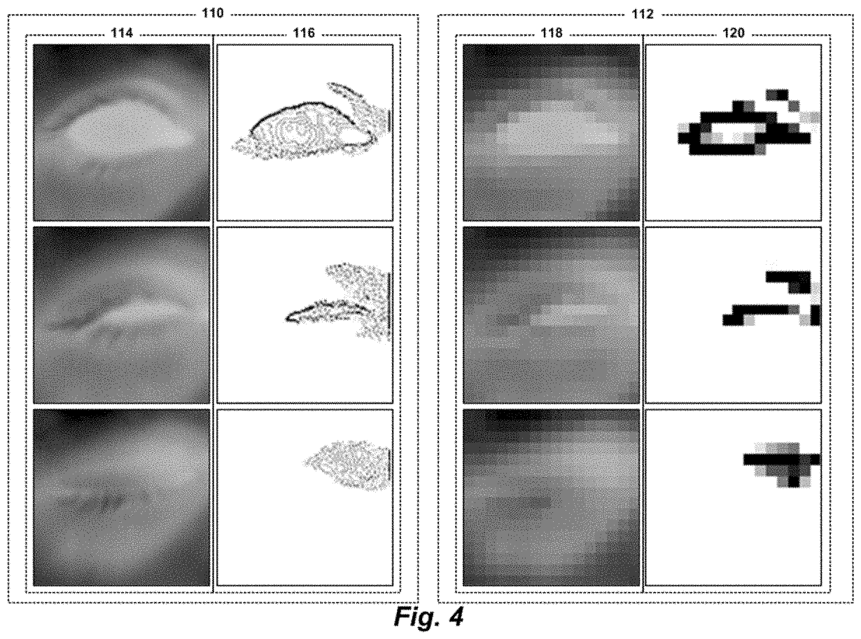

Important concerns in the design and use of such systems are expense, size, and power demand. High-resolution infrared imaging devices are large and relatively high power, but lower-resolution devices in the range of 16×16 pixels or more are available for vastly lower prices, and are very small and low power; as time as gone on, low-cost infrared imaging at higher resolutions is becoming increasingly available. For the purposes of the functionality discussed in this patent, even such low resolution as described is sufficient. FIG. 4 demonstrates the capability of such low resolution imaging. High resolution images 110 are compared with low resolution images 112; the original high-resolution images 114 are transformed to edge-only images 116, and the same process performed on original low-resolution images 118 produces the low-resolution edge-only images 120.

Both high resolution 110 and low resolution 112 sequences show an eye closing. As can be seen, while the low resolution images 112 are “blockier” and lack details (e.g., eyelashes) which can be detected in the high resolution images 114, the basic requisite features—the eyeball and eyelids—are clearly visible and are defined by detectable edges in even the low-resolution edge images 120. With the application of simple rules and the control of the field of view afforded by installation of the imaging sensors in a mask whose geometry is known to a reasonable degree, it is therefore not only possible to determine that the eye is open (and thus suitable for temperature measurement) but to determine features such as the position of the eyelids. Additional analysis of the images over time can be used to track the average eyelid position, frequency of blinks, and other statistics which have been shown to be associated with fatigue and attentiveness. It is also possible to detect and track gaze direction even with the low resolution images.

As the principal focus of the preferred embodiment is for use on free-swimming divers, in the principal embodiment the major method of communication of data to a remote site (master diver, etc.) is wireless; in general this means acoustic data transmission. Acoustic data transmission has been used for a number of years underwater, and currently represents the only practical means known for wireless, long range data transmission through water of natural composition (very pure water may permit light-based transmission, but the turbidity and other aspects of natural waters render such things unreliable in real-life situations); very low-frequency radio waves may also be transmitted through water, but the allowable frequencies (which may be in the range of hundreds of Hz or even less) severely limit the amount of data that can be transmitted, and generally require excessively large antenna arrays. There are of course challenges associated with acoustic communication, one of the most noticeable being acoustically dead “shadow zones” which can form due to particular combinations of water temperature and density layers; such shadow zones are areas in which there is no acoustical path for a given frequency of sound between something in the shadow zone and the location of the receiver.

This is one reason for insuring that the combination of sensor node 20 and local data collection and processing unit 18 is, itself, sufficient to make a determination as to the existence of any potentially dangerous situation. Another obvious option for the design of the system would be to include several different wavebands for communication; if one waveband does not show a response, another may be tried and may be able to communicate out of another waveband's shadow zones, as the propagation of acoustic signals is heavily dependent upon wavelength of the signal.

In any event, while the sensor nodes 20 could be connected via wires, or via conductive paths in the wetsuit, to the local processing device 18, and while such connections could be made more or less convenient by the use of appropriate fasteners which served a dual purpose of physical connection of portions of the diver's wetsuit/mask/etc., and of electrical connectivity for the sensors, it is clear that there would be a significant advantage to making these short-range connections wireless. Wires can break, connections fail or corrode, and so on, especially in a salt water environment.

While acoustic communication can be used for short as well as long-haul, it is also possible to use RF (radio) for this purpose over short distances. The attenuation through a medium is generally given by the formula

α=0.0173 √(fσ), where

α=Attenuation in dB/meter, f=frequency in Hz and Σ=conductivity in mhos/meter.

Given the conductivity of seawater (which can vary by a factor of 2-4 times depending on exact location, time of year, etc.), calculations and experiments show that frequencies of roughly 100 kHz or less would permit transceivers to operate in short ranges of a few meters. For the present invention, a small chip-based modem device may be incorporated into the sensor nodes 20, with an equivalent modem in the central data collection and processing system 18, which would drive a RF transmitter using some form of frequency based coding (as the attenuation of the medium and variability of that attenuation would make amplitude-based coding extremely problematic). While occasional experiments have been performed on transmission of RF in water, there are no references to the application of radio to underwater BAN (Body Area Networks) with the attendant advantages and features thereof. Additional advantages lie in the area of stealth, which is a significant concern in military applications, and these and other aspects of underwater biomedical networks are discussed in a separate patent application.

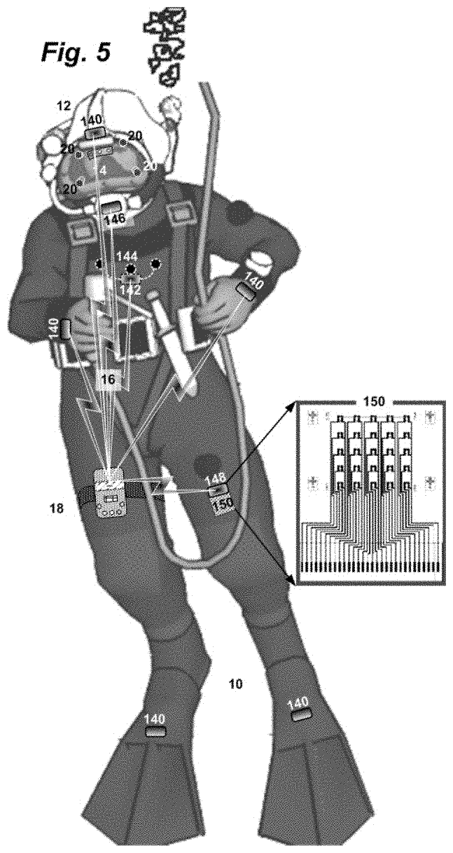

With this discussion and prior discussion, it should be obvious that the system described could and, in a real-life embodiment likely would, incorporate a number of sensors rather than just one. FIG. 5 shows one version of such an embodiment, which includes the original infrared imaging sensors 20, but also includes a number of others. On the helmet 12 is an accelerometer sensor node 140; additional accelerometer nodes 140 are placed on the arms and legs. Together these accelerometers 140 provide data which can allow the overall system to:

1) Track the orientation of the diver. It is well-known by those in charge of diving operations that human beings, even underwater, rarely assume a head-down orientation unless they are either constrained to do so by task (diving, working on some object which can only be reached in that manner), or have become confused or disoriented. Tracking the diver's vertical orientation, therefore, may be extremely useful in determining whether a diver is disoriented. This could be used in combination with an in-mask display, an enhanced version of display 22, which would be provided with an LED display that could show the direction of “up” for the diver.

2) Track patterns of movement. Swimming motions of a trained diver are smooth and rhythmic. A diver who is confused, panicked, or disoriented will often exhibit significantly more erratic patterns of motion.

3) Determine if current actions are appropriate. If a diver is expected to be performing some particular task (swimming to a given location, welding a particular structure, waiting to decompress at a given level), tracking the movement of limbs and head will help verify whether they are indeed performing the expected actions; a diver who is confused or in trouble will not be performing the expected task.

Continuing with FIG. 5, another parameter is monitored by an EKG (Electrocardiogram) sensor node 142; as multiple electrodes 144 are needed (shown as dotted lines, beneath/incorporated into wetsuit), there may be a single sensor node 142 connected to the electrodes 144 by wires, or one node 142 for each EKG electrode 144. Note that the electrodes 144 are not standard EKG electrodes unless the diver 10 is wearing a drysuit, since standard EKG electrodes rely on conductivity, and seawater's conductivity would effectively short the electrodes out. Electrodes for use in seawater will use some other characteristic which can be controlled—possibly capacitance, inductance, or some other approach—or will be designed in a manner that allows them to seal to the skin without allowing direct contact with the water; alternatively, it may be possible that a combination of sensing the exact salinity of the water with compensation and calibration processing would allow standard sensors to be used.

A hydration monitor node 146 may be incorporated into the breathing apparatus if it is mouth-held, using an osmolality-based salival sensor. It is possible other methods, such as tracking the amount of water in the exhaled air, would be useful as well. If an oronasal mask or other means of breathing which do not rely on a mouthpiece are used, other means of determining hydration are possible.

For example, in FIG. 5, sampling sensor node 148 is connected to a microscale interstitial fluid sampling array 150. Such an array, demonstrated by Castracane et. al., permits direct sampling of interstitial fluid without actual damage to the individual. Each sample of fluid may be examined by one or more types of sensors; in the preferred embodiment it is envisioned that such an array would be designed to sample blood gases such as oxygen, nitrogen, etc., but could also easily be used to determine blood osmolality and thus hydration.

The data collection and processing unit 18 itself may have its own sensors, especially environmental sensors which may be used in conjunction with the personal monitoring sensor nodes; temperature, salinity, pressure, and other characteristics may be monitored and factored into account in any data processing performed.

The system and methods described above may be embodied in many ways other than the preferred embodiment described previously. Some examples are as follows:

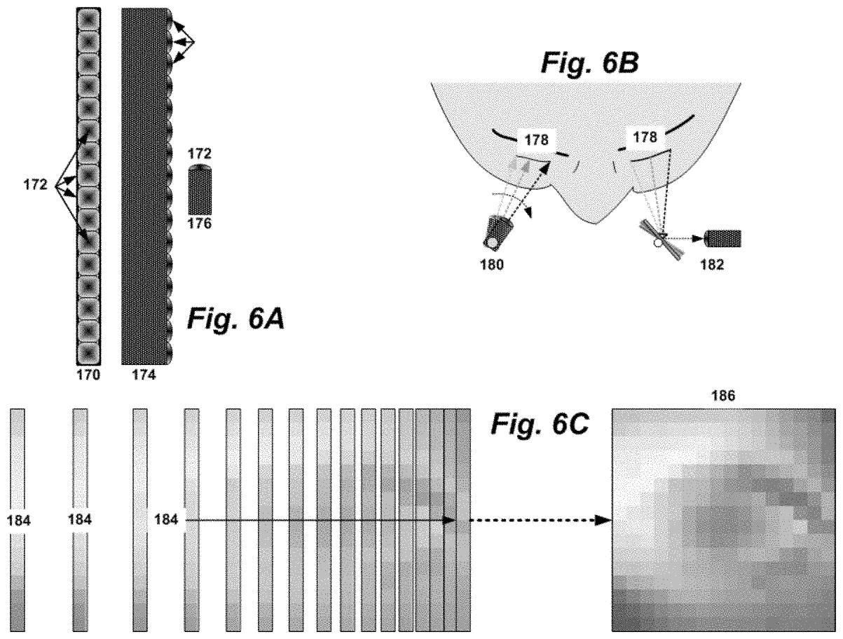

1. Line-scanning IR imaging. 2-D imaging arrays are the obvious method by which an infrared image of a scene may be obtained, but they are not the only method. Another common means which can produce high-resolution images involves the use of a linear array (a 1-d array of IR sensors) which is scanned across the target field of view in a regular fashion. FIG. 6 shows this concept.

In FIG. 6A is shown a general diagram of a 1D or linear array—a front view 170, a side view 174, and a top view 176, composed of some number (in this case 16) individual infrared sensors/pixels 172. These sensors may have individually integrated lenses or there may be a single lens assembly covering the linear array. In order to assemble a full image with such an array, the scene in front of the array must be scanned so that successive segments of the scene (preferably evenly separated) are acquired in sequence for assembly as a single image.

FIG. 6B illustrates two conceptual methods of achieving this. A target subject's eyes 178 are scanned by two methods. The first method 180 assumes some design which incorporates a pivoting motor/shaft connected to the linear array. The motor is controlled such that it regularly sweeps from one side of the eye 178 to the other and the linear array acquires linear images 184 at regular intervals during the sweep. The second method 182 places the linear array in a fixed assembly but uses a mirror on a pivoting or otherwise movable mounting to scan the eye 178 in a controlled fashion similar to method 180. It should be noted that any method of moving these elements described, including standard motors, piezoelectric actuators, or others may be used for these purposes.

After each sequence of acquisition, the linear images 184 are assembled in order, producing a single unified image 186 whose dimensions are equal to the number of linear sensor elements 172 times the number of linear images 184 acquired in each sequence. In this case, image 186 is 16×16—the same resolution discussed for low resolution acquisition previously.

2. Temporary/Ad Hoc sensor network. The preferred embodiment seen in FIGS. 1 and 5 integrates the sensing components into the diver's equipment. There are a number of situations in which one can envision that such sensors might be needed but there would be no opportunity or resources available to integrate them into the diver's equipment, or in which a diver might wish to purchase a core system and supplement it later with more capabilities. In this embodiment, the sensors would be separate items which would be designed such that they could be added to the diving equipment as needed; in general, this would also mean designing the sensors to be compatible with the communications and interface protocols.

For example, a sensor node might be designed which would incorporate the IR sensors described earlier, and which had a rear design such that it would fit some set of standard masks, and some method of temporarily fastening it to the standard mask—suction cups, a sticky but removable substance, Velcro®, a clip mechanism, etc. Similarly, accelerometer sensors could be supplied as wristband and ankle-band mounted devices, with another to clip to the top of a mask, wear as a headband, etc., the EKG sensors applied in a chest-band, and so on. This approach could make the system much more flexible and affordable than the integrated complete system previously illustrated.

3. Monitor for other animals. It should be clear that there is nothing that inherently limits the use of this BAN monitoring concept to a human body. A creature (for instance, a seal or dolphin) could be equipped with sensor nodes to monitor its condition in the same fashion.

4. Soldiers or researchers in extreme environments. While the preferred embodiment focuses on divers, many of the same challenges and issues apply to other extreme environments. For example, a person working in Arctic or Antarctic conditions is subject to similar restrictions and hazards, leaving aside the issue of breathing. A similar embodiment of the invention, incorporated into snow goggles and winter clothing, may be envisioned and is specifically covered herein.

5. Sensors contained within and integrated with the data collection and processing unit 18. While the sensors 20 in FIG. 1 and other sensors shown in FIG. 5 are shown to be separate and distinct from the data collection and processing unit 18, there is no necessity that this be the case. While this might preclude certain functions (e.g., at the displayed size in FIG. 5 it would be difficult to envision such a system being affixed to the faceplate 14 without ruining the field of view), other functions such as accelerometer measurements, environmental monitoring, EKG monitoring (if affixed to the chest area) and so on may be envisioned. The advantage of this design is a reduction in components and the reduction in the need for a BAN; data can also be acquired and processed at much more rapid speeds since the data transmission to the data collection and processing unit 18 is no longer limited by the RF or acoustic links.

6. Scientific data collection. Human subjects of various types of experiments can be very difficult to monitor directly. A system such as that described in this patent would provide means to instrument a human subject for virtually any sort of experiment or data-collection requirement without needing physical data connections.

7. Athletes. Both professional and serious amateur athletes, ranging from players of football to marathon or triathletes and others, subject their bodies to extreme stress, and if they cannot monitor their condition, are at risk for injury or even death. A lightweight sensing system which did not interfere with the performance of the sport while still monitoring key elements such as body temperature, hydration, and heart-lung function would be an invaluable addition to the equipment of such professional and serious amateur athletes.

The foregoing description of various embodiments of this invention has been presented for purposes of illustration and description. It is not intended to be exhaustive or to limit the invention to the precise form disclosed and inherently many more modifications and variations are possible. All such modifications and variations that may be apparent to persons skilled in the art that are exposed to the concepts described herein or in the actual work product, are intended to be included within the scope of this invention.

What is claimed is:

1. A system for monitoring the condition of a living object, the system comprising:
at least one imaging device;
optics providing close focus capability;
a mounting object to allow for a field of view that includes at least a portion of one of the objects eyes;
an interface for acquiring data from at least one imaging device; and
a controller, in communication with the imaging device, is configured to
Determine at least one biological characteristic of the object,
Generate an alert or signal if the characteristic is outside of specified values.

2. The system of claim 1, wherein the living object is a human being.

3. The system of claim 2, wherein the living object is a human underwater diver.

4. The system of claim 3, wherein the support structure is incorporated into a diver's mask or helmet.

5. The system of claim 1, wherein the imaging device utilizes an infrared detector.

6. The system of claim 1, wherein at least one of the biological characteristics included body temperature.

7. The system of claim 1, wherein the communication to the imaging device includes a wired connection.

8. The system of claim 1, wherein the communication to the imaging device includes a wireless connection.

9. The system of claim 1, wherein the controller is configured to communicate with a plurality of imaging devices.

10. The system of claim 3, wherein the controller is configured to communicate with a plurality of human underwater divers.

11. A method for monitoring the condition of a living object, the method comprising:
obtaining at least one image of the objects eye;
communication of data from at least part of the image to a controller;
detecting, by the controller, at least one biological characteristic;
generating, by the controller, an alert when the biological characteristic is not within specified values.

12. The method of claim 11, wherein the living object is a human.

13. The method of claim 12, wherein the human is an underwater diver.

14. The method of claim 11, wherein the image is obtained by an infrared camera.

15. The method of claim 14, wherein at least one of the biological characteristics is body temperature.

16. The method of claim 11, wherein the communication method to the controller is through a wired connection.

17. The method of claim 11, wherein the communication method to the controller is through a wireless connection.

18. The method of claim 11, wherein the controller obtains data from at least one additional sensor for the collection of biological information.

19. The method of claim 11, wherein the controller is configured to communicate with at least one other controller.

20. The method of claim 11, wherein the controller is configured to communicate with a data storage system.
